(19) United States
(12) Patent Application Publication
(10) Pub. No.: US 2012/0174722 A1
(43) Pub. Date: Jul. 12, 2012

(54) CUTTING BLADE

(75) Inventor: Günther Weber, Gross Nemerow (DE)

(73) Assignee: WEBER MASCHINENBAU GMBH BREIDENBACH, Breidenbach (DE)

(21) Appl. No.: 13/380,369

(22) PCT Filed: Jun. 16, 2010
(86) PCT No.: PCT/EP2010/003600

§ 371 Date: Mar. 9, 2012

(30) Foreign Application Priority Data
Jun. 25, 2009 (DE) 102009030550.5

(51) Int. Cl. B26D 1/14; B26D 7/06

(52) U.S. Cl. 83/401; 83/651; 83/663

(57) ABSTRACT

A device for cutting food products is provided. The device comprises a cutting blade having a main part defining a cutting plane and a reinforcing part connected to the main part. At least one cavity is formed between the main part and the reinforcing part.

The present invention relates to a cutting blade for machines for slicing food products, in particular for high-performance slicers, having a base body defining a cutting plane.

Such cutting blades are used for slicing sausage, ham, cheese and other food products at a high cutting sequence and are therefore exposed to high loads in operation. The demands on the stiffness and strength of such cutting blades are very high for this reason. In the sense of a high cutting quality, it is endeavored to position the cutting plane of the cutting blade as close as possible to an associated counter-blade. If the blade, however, deforms during operation due to the load, an unwanted collision between the blade and the counter-blade can arise or an increase in the cutting gap impairing the cutting quality can arise.

For this reason, an increase in the blade stiffness is still aimed for. At the same time, the cutting blade of the named kind should, however, not be formed excessively solidly, that is should in particular have a relatively low weight. Cutting blades which are complicated and complex to manufacture are equally unwanted.

It is therefore the object of the invention to provide a cutting blade having increased stiffness which is simple to manufacture.

This is satisfied by a cutting blade having the features of claim 1 and by an apparatus for slicing food products having the features of claim 15. In accordance with the invention, the cutting blade has at least one stiffening body connected to the base body, with at least one hollow space being formed between the base body and the stiffening body.

The strength of the cutting blade can be significantly increased in this manner with a relatively small additional material effort. A section-like stiffening structure is formed by the hollow space configuration, whereby deformations of the cutting blade which are all too strong are avoided during operation. The circumstance is of special advantage that it is not, for instance, a completely new type of cutting blade which has to be designed and produced, but that rather only an additional stiffening body has to be manufactured and to be attached to a base body—which can generally be of a known type. The cutting edge of the cutting blade can be formed directly at the base body. Alternatively, a separate cutting element can also be provided which is attached—e.g. replaceably—to the base body.

The stiffening body is preferably a component which is separate from the base body of the blade and which is connected to the base body or attached or secured to the base body in generally any desired manner, in particular releasably.

The hollow space can, but does not absolutely necessarily have to be completely closed (in particular for hygienic reasons).

In accordance with an embodiment, the hollow space extends peripherally about a surface normal of the cutting plane, in particular about the axis of rotation of the blade. In this manner, a relatively uniform stabilization of the cutting blade over the cutting plane can be achieved.

In accordance with a further embodiment, the hollow space is sealed with respect to the environment. A hygienically unfavorable collection of product remainders in the hollow space is thus avoided.

The stiffening body can be welded to the base body in order in this manner to provide a uniformly firm and tight connection between the two bodies.

In accordance with an embodiment, the stiffening body is attached to the base body on the side of the cutting blade facing the product. Arched portions or elevated portions can then be located on the side remote from the product for the further stiffening of the blade.

The stiffening body can be designed as a plate-like or disk-like sheet metal part. Such a component is simple and inexpensive in manufacture and thus does not make the manufacturing process of the cutting blade excessively more expensive.

In accordance with an embodiment, the stiffening body is designed at least partially in the form of a circular ring and/or the stiffening body has the form of a closed ring. Components, in particular sheet metal parts, having such simple geometries are particularly simple to manufacture.

The base body can be made in the form of a plate or of a disk. The cutting blade can therefore in particular be formed by two disk-shaped components which are placed over one another, with the hollow space having a relatively small extent at a right angle to the cutting plane.

In accordance with an embodiment, the hollow space is formed at least partly by a recess of the base body which is at least partly covered by the stiffening body. No further measures are then necessary to produce the hollow space, but already existing arched portions or elevated portions in the base body, which in particular likewise serve for the stiffening, are rather used in an advantageous manner to provide a hollow space structure by means of a simple component, in particular of a cover type.

The base body can have at least one onset whose contour is matched to a contour of the stiffening body. A form-fitted connection between the base body and the stiffening body can thereby be provided by which the strength of the cutting blade is further increased. Furthermore, the manufacture of the cutting blade is simplified in this embodiment since the onset can be used for positioning the stiffening body at the base body.

In accordance with a further embodiment, the stiffening body is formed in ring shape and the base body has two concentrically peripheral onsets whose contours are matched to an outer contour and an inner contour of the ring-shaped stiffening body, with in particular the base body being welded to the stiffening body and the weld points extending along the onsets. The stiffening body is therefore inserted between the two onsets of the base body during the manufacture and welded along the peripheral margins.

In accordance with a further embodiment, a substantially flush transition is provided between the base body and the stiffening body. In particular edges and projections can thereby be avoided which are unfavorable in a hygienic aspect.

In accordance with a further embodiment, the stiffening body is disposed at least substantially on the side of the cutting plane remote from the product. This therefore means that the stiffening body is set back somewhat with respect to the cutting plane so that it does not come into direct contact with the product to be sliced.

The cutting blade can in particular be designed, depending on the application, both as a rotating circular blade and as a circular blade revolving in planetary motion or as a scythe-like blade, spiral blade or cutter blade, in particular rotating.

Possible further embodiments of the invention are also set forth in the dependent claims, in the drawing and in the description.

The invention will be described in the following with reference to the drawing.

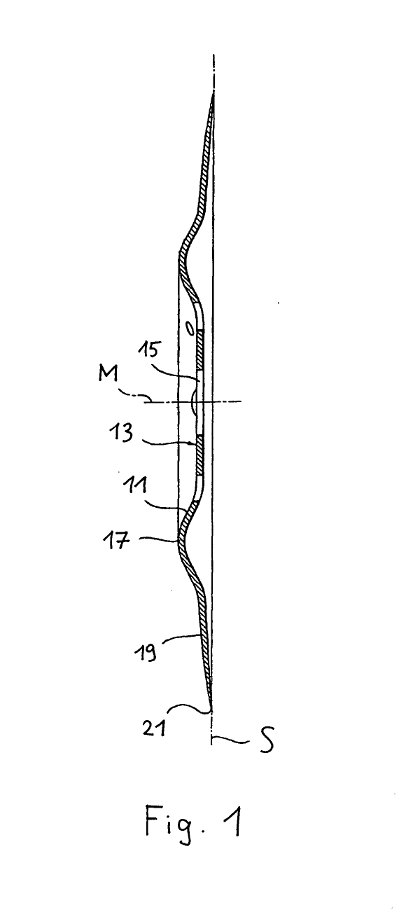

FIG. 1 shows a cross-sectional view of a cutting blade in accordance with the prior art;

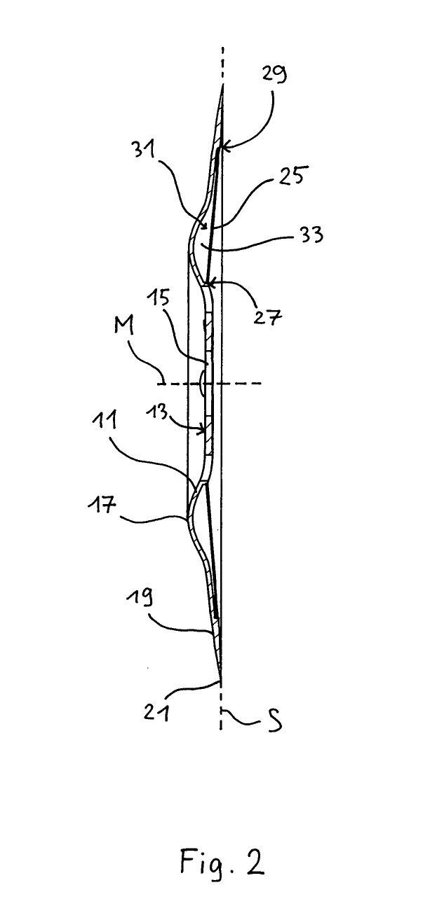

FIG. 2 shows a cross-sectional view of a cutting blade in accordance with the invention; and

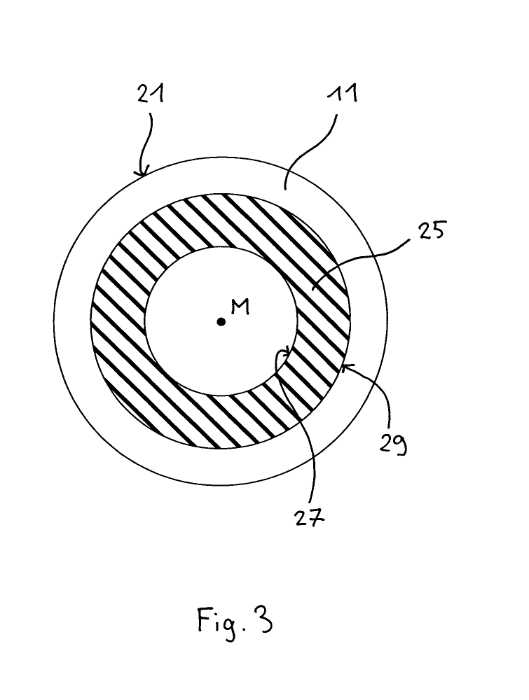

FIG. 3 shows a plan view of the side of the cutting blade facing the product in accordance with FIG. 2.

In accordance with FIG. 1, a base body 11 of a known cutting blade for a high-performance slicer includes a central securing region formed substantially planar and with a central opening 15. This opening 15 serves for securing purposes in the case of a circular blade and for centration in the case of a scythe-like blade, with a plurality of securing openings arranged distributed around the opening 15 with a radial spacing from the opening 15 being provided with such a scythe-like blade.

The central securing zone 13 merges radially outwardly into an arched portion 17 which forms a stabilizing zone or stiffening zone. The arched portion 17, which is continuously curved in cross-section, surrounds the central securing zone 13 such that it lies in a depression in a practically recessed manner. A marginal zone 19 in turn radially outwardly adjoins the arched portion 17 and its periphery is made as a cutting edge 21. A cutting plane S which extends at a right angle to a blade axis M is defined by the cutting edge 21.

A cutting blade in accordance with an embodiment of the invention is shown in FIGS. 2 and 3. The base body 11 of the cutting blade in accordance with the invention is in principle of a similar design to that of the cutting blade in accordance with FIG. 1 so that the same reference numerals are also used. A stiffening body 25, which is here designed as a circular ring-shaped metal plate, is attached in the region of the arched portion 17 of the base body 11 to increase the strength and stiffness of the blade. The stiffening body 25 is inserted between two concentrically peripheral onsets 27, 29 formed at the base body 11 and is welded to the base body 11, with weld points not shown in the Figures extending continuously peripherally along the onsets 27, 29. The stiffening body 25 thus completely covers the depression-like recess 31 formed by the arched portion 17, whereby a hollow space 33 is produced between the base body 11 and the stiffening body 25.

The hollow space 33 is hermetically sealed with respect to the environment by the weld points completely peripheral along the onsets 27, 29.

The onsets 27, 29 are matched to the material thickness of the stiffening body 25 so that a flush transition results overall between the base body 11 and the stiffening body 25. As can be seen from FIG. 2, the stiffening body 35 is set back by a specific amount in the axial direction with respect to the cutting plane S.

During operation, a product to be sliced is supplied from the cutting plane S by means of a product feed from the side at the right in FIG. 2. During the cutting procedure, the cutting edge 21 of the cutting blade cooperates with an end element of the product feed formed as a counter-blade in order thus to cut product slices from the product bar. The air gap formed between the end element and the cutting edge 21 can be particularly small due to the increased strength or stiffness of the cutting blade in accordance with the invention, whereby an ideal cutting quality results. An unwanted deformation of the cutting blade is prevented by the section-like structure which results due to the hollow space 33. It is of particular advantage that in accordance with the invention only simple and inexpensive modifications to existing cutting blades have to be carried out in order significantly to increase their strength and stiffness.

### Reference Numeral List

11 base body
13 securing zone
15 opening
17 arched portion
19 marginal region
21 cutting edge
25 stiffening body
27 onset
29 onset
31 recess
33 hollow space
S cutting plane
M blade axis
feed direction

1-15. (canceled)

16. A cutting blade for machines for slicing food products comprising:
a base body defining a cutting plane and having at least one stiffening body connected to the base body, wherein at least one hollow space is formed between the base body and the stiffening body.

17. A cutting blade in accordance with claim 16, wherein the cutting blade is configured for use in a high-speed slicer.

18. A cutting blade in accordance with claim 16, wherein the hollow space extends peripherally about a surface normal of the cutting plane.

19. A cutting blade in accordance with claim 18, wherein the hollow space extends peripherally about a blade axis.

20. A cutting knife in accordance with claim 16, wherein the hollow space is sealed with respect to the environment.

21. A cutting blade in accordance with claim 16, wherein the stiffening body is welded to the base body.

22. A cutting blade in accordance with claim 16, wherein the stiffening body is attached to the base body at the side of the cutting blade facing the product.

23. A cutting blade in accordance with claim 16, wherein the stiffening body is formed as a plate-like or disk-like part.

24. A cutting blade in accordance with claim 16, wherein the stiffening body is formed as a sheet metal part.

25. A cutting blade in accordance with claim 16, wherein the stiffening body is formed at least partially as a circular ring; and/or wherein the stiffening body has the form of a closed ring.

26. A cutting blade in accordance with claim 16, wherein the base body is made plate-like or disk-like.

27. A cutting blade in accordance with claim 16, wherein the hollow space is formed at least partly by a recess of the base body which is covered at least partly by the stiffening body.

28. A cutting blade in accordance with claim 16, wherein the base body has at least one onset whose contour is matched to a contour of the stiffening body.

29. A cutting blade in accordance with claim 28, wherein the stiffening body is made in ring form and the base body has two concentrically peripheral onsets whose contours are matched to an outer contour and an inner contour of the ring-shaped stiffening body.

30. A cutting blade in accordance with claim 29, wherein the base body is welded to the stiffening body and the weld points extend along the onsets.

31. A cutting blade in accordance with claim 16, wherein a substantially flush transition is provided between the base body and the stiffening body.

32. A cutting blade in accordance with claim 16, wherein the stiffening body is disposed at least substantially on the side of the cutting plane remote from the product.

33. A cutting blade in accordance with claim 16, wherein the cutting blade is formed both as a rotating circular blade and as a circular blade revolving in planetary motion or as a scythe-like blade, spiral blade or cutter blade.

34. An apparatus for slicing food products, comprising:
a product feed which supplies one or more products to be sliced to a cutting plane in which at least one cutting blade moves, wherein the cutting blade has a base body defining a cutting plane and has at least one stiffening body connected to the base body, wherein at least one hollow space is formed between the base body and the stiffening body.

35. An apparatus in accordance with claim 19, wherein said apparatus is a high-performance slicer.

36. An apparatus in accordance with claim 19, wherein, in operation, the cutting blade moves in a rotating and/or revolving manner.
